(19) United States
(12) Patent Application Publication
(10) Pub. No.: US 2012/0063738 A1
(43) Pub. Date: Mar. 15, 2012

(54) DIGITAL VIDEO RECORDER SYSTEM AND OPERATING METHOD THEREOF

(76) Inventor: Jae Min Yoon, Gyeonggi-do (KR)

(21) Appl. No.: 13/321,504

(22) PCT Filed: May 18, 2010
(86) PCT No.: PCT/KR10/03124

§ 371 Date: Nov. 18, 2011

(30) Foreign Application Priority Data
May 18, 2009 (KR) 10-2009-0043299
Feb. 22, 2010 (KR) 10-2010-0015788

(51) Int. Cl. H04N 5/77; H04N 5/765; H04N 9/80

(52) U.S. Cl. 386/224; 386/241; 386/200; 386/E05.069; 386/E05.002; 386/E09.011

(57) ABSTRACT

The present invention relates to a digital video recorder system and a method for operating the same that classifies sounds sensed by a microphone for each type and stores videos in a range where sounds are generated to search the videos for each sound type, thereby making it possible to more rapidly search the videos.

The present invention includes a camera inputting videos; a microphone inputting sounds; a sound video recorder unit that converts videos and sounds input from the camera and the microphone into digital signals; a sound recognizing unit that analyzes sound converted into the digital signals and classifies the sound type; an video managing unit that manages the video in a range where the specific sounds are generated; a sound video file storage unit that manages the range where the specific sounds are generated in an video file and stores it in a database; an video DB that stores the general video recording file; a sound video DB that stores an video file where the sounds are generated; a sound video information DB that stores the information on the video file for each sound type; a sound video searching unit that searches the video file stored in the video DB, the sound video DB, and the sound video information DB according to the search request of the video file; and a sound video display managing unit that is connected to a user interface to provide the search function of the video file and reproduce the searched video file.

### BACKGROUND OF THE INVENTION

1. Field of the Invention

The present invention relates to a digital video recorder system and an operating method thereof, and more particularly, to a digital video recorder system capable of more rapidly searching videos by identifying sounds sensed by a microphone for each sound type and storing videos in a range where sounds are generated in order to search the videos depending on each sound type.

2. Description of the Related Art

Generally, a digital video recorder (hereinafter, referred to as DVR) system means a device that can record videos in a hard disk based storage device rather than a video tape. This digital video recorder is also referred to as a personal video recorder (PVR).

The DVR system is a high-resolution recording system that converts video data input as analog signals from at least one supervisory camera into digital signals and then compresses and stores videos using a moving picture experts group (MPEG) that is a moving picture international compression standard and if necessary, can view the stored compression videos by recovering and playing them.

With the technical development, a high definition video recorder system and a device capable of recognizing a face are being developed. The device capable of recognizing a face uses real-time monitored videos and faces of specific characters as a database to confirm and identify a face, such that it has been mainly used for security in a police station, an airport, etc.

In addition, a DVR system storing only the moving picture range where motions are generated by using various types of motion recognition algorithms has been commercialized in processing the videos of the DVR system.

However, the video information as well as the sound information is very important. In particular, when wishing to search and view locations of video where sounds of specific accidents are generated in a parking lot where minor collision between cars frequently occurs, a road section where traffic accident frequently occurs, etc., a large amount of information that are missed in the existing video search can be more precisely observed and analyzed.

In addition, if there is an apparatus enabling a user to freely reproduce videos where specific sounds are generated by storing the video range in which the corresponding sounds are generated by classifying videos depending on each sound type, it will save the user trouble of reproducing all the recorded videos and searching them one by one.

For the above-mentioned reason, the existing DVR system stores the video data for all the ranges or a range in which motions are generated by date and by time, such that it cannot search only the range in which the specific sound are generated. Further, the technical development of the existing DVR system has been concentrated only the video processing technology without considering the important factors such as sound.

Therefore, in order for the existing DVR system to search and analyze the videos in the specific range in the stored video data, there is a problem in that it is inconvenient to recover and reproduce all the stored videos in time sequence.

### SUMMARY OF THE INVENTION

As an aspect of the present invention provides a digital video recorder system and a method using the same capable of receiving sound video data through a microphone and a camera, classifying sounds sensed by the microphone for each sound type, and storing videos in a range where sounds are generated according the sound type in a storage medium to search and reproduce the videos where specific sounds are generated for each sound type, thereby making it possible to more rapidly search the corresponding videos in the range where the sound are generated.

In other words, the present invention generates and stores one video file and reproduces the video file in a range where the corresponding sounds are generated.

According to an exemplary embodiment of the present invention, there is provided a digital video recorder system, including: an video recorder unit that records videos in monitoring areas; a sound input unit that inputs sounds in the monitoring areas; a DVR device that classifies the sounds for each type by recognizing the sounds in the monitoring areas, stores an video or range information where specific sounds are generated, and accesses the corresponding videos and outputs them to an output device according to the search request of the videos for the specific sounds.

According to another exemplary embodiment of the present invention, there is provided a digital video recorder system, including: a camera that input videos; a microphone that inputs sounds; a sound video recorder unit that converts videos and sounds input from a camera and a microphone into digital signals; a sound recognizing unit that analyzes the sounds converted into the digital signals and classifies a sound type; an video managing unit that manages the videos in a range where general recording videos and specific sounds are generated; a sound video file storage unit that stores the videos where the general videos and the specific sounds are generated and range information where the specific sounds are generated; an video DB that stores a general video recording file; a sound video DB that stores an video file in a time range where the sounds are generated; a sound video information DB that stores path information and time range information on the video files for each sound type; a sound video searching unit that searches the video information stored in the video DB, the sound video DB, and the sound video information DB according to the search request of the video information where the specific sounds are generated; and a sound video display managing unit that is connected to a user interface and provides the search function of the video information and reproduces the searched video information.

According to still another exemplary embodiment of the present invention, there is provided a method for operating a digital video recorder system, including: receiving videos and sound data; analyzing the sound data to recognizing specific sounds; storing only video data in a database as an video file of the corresponding time period, including a sound type and information on generating time and ending time when the specific sounds are recognized; and searching videos in a database according to requested conditions and reproducing them as the output of the sounds and the videos when the search of the stored video file is detected.

According to yet still another exemplary embodiment of the present invention, there is provided a method for operating a digital video recorder system, including: receiving videos and sound data; analyzing the sound data to recognizing specific sounds; synchronizing and compressing and storing videos and sound data; storing a sound type and information on generating time and ending time in a database when the specific sounds are recognized; and searching an video file in the database according to requested conditions when the video search is requested for a range where the stored specific sounds are generated and reproducing the video range corresponding to the generating time and the ending time where the specific sound is recognized as the output of the sound and videos.

### BRIEF DESCRIPTION OF THE DRAWINGS

FIG. 1 is a diagram showing a configuration of a digital video recorder system according to an exemplary embodiment of the present invention;

FIG. 2 is a diagram showing a detailed configuration of a sound video display managing unit in the digital video recorder system according to the exemplary embodiment of the present invention;

FIG. 3 is a diagram showing a file information structure generated from the digital video recorder system according to the exemplary embodiment of the present invention;

FIG. 4 is a diagram showing another example of a file information structure generated from the digital video recorder system according to the exemplary embodiment of the present invention;

FIG. 5 is a diagram showing a process of storing a sound video file in the digital video recorder system according to the exemplary embodiment of the present invention;

FIG. 6 is a diagram showing a process of storing a sound video file and a sound file in the digital video recorder system according to the exemplary embodiment of the present invention;

FIG. 7 is a diagram showing a process of generating a sound video information DB in the digital video recorder system according to the exemplary embodiment of the present invention;

FIG. 8 is a diagram schematically showing an operational process of the digital video recorder system according to an exemplary embodiment of the present invention;

FIG. 9 is a diagram schematically showing another example of an operational process of the digital video recorder system according to an exemplary embodiment of the present invention;

FIG. 10 is a diagram schematically showing still another example of an operational process of the digital video recorder system according to an exemplary embodiment of the present invention;

FIG. 11 is a diagram showing a process of storing a video file of a digital video recorder system according to an exemplary embodiment of the present invention;

FIG. 12 is a diagram showing another example of a process of storing a video file of a digital video recorder system according to an exemplary embodiment of the present invention;

FIG. 13 is a diagram showing a process of searching a sound video file of a digital video recorder system according to an exemplary embodiment of the present invention;

FIG. 14 is a diagram showing a screen for searching a sound video file of a digital video recorder system according to an exemplary embodiment of the present invention;

FIG. 15 is a diagram showing another example of a screen for searching a sound video file of a digital video recorder system according to an exemplary embodiment of the present invention;

FIG. 16 is a diagram showing still another example of a screen for searching a sound video file of a digital video recorder system according to an exemplary embodiment of the present invention;

FIG. 17 is a diagram showing a range video file list in a digital video recorder system according to an exemplary embodiment of the present invention;

FIG. 18 is a diagram showing another example of a range video file list in a digital video recorder system according to an exemplary embodiment of the present invention; and

FIG. 19 is a diagram showing a process of performing a search of sound video file of a digital video recorder system according to an exemplary embodiment of the present invention.

### DETAILED DESCRIPTION OF THE PREFERRED EMBODIMENTS

An exemplary embodiment of the present invention will now be described in detail with reference to the accompanying drawings.

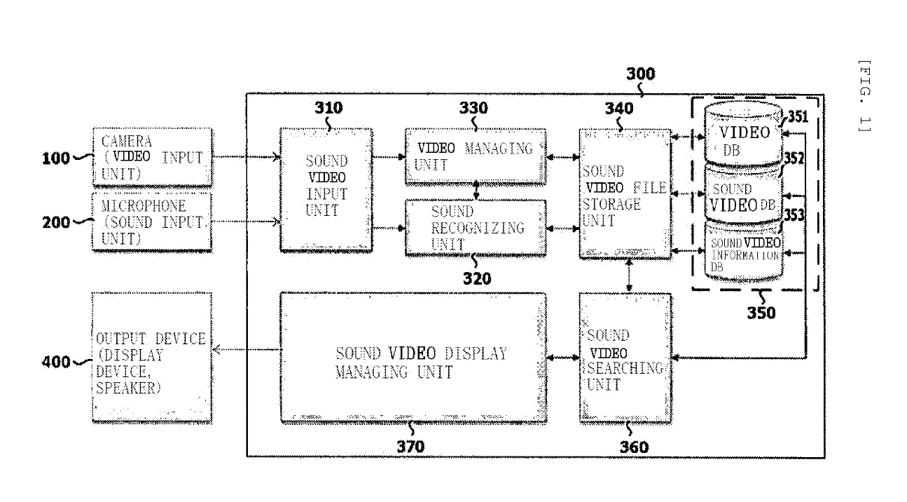

FIG. 1 is a diagram illustrating a configuration of a digital video recorder system according to an exemplary embodiment of the present invention.

The present invention is configured to include a camera 100, a microphone 200, a DVR device 300, and an output device 400.

The camera 100 is a camera in a digital scheme and an analog scheme. The camera 100 recording videos in monitoring areas by adjusting an angle of the cameras installed in the areas and inputs the recorded video information to the DVR device 300.

As the microphone 200, a dynamic microphone, a condenser microphone, a ribbon microphone may be used according to a structure of a microphone and a directional microphone, a non-directional microphone, a uni-directional microphone, a super directional microphone (super cardioid, hyper cardioid), etc., may be used according to directivity. Therefore, at least any one of the above-mentioned microphone may be used, but the directional microphone is preferably used in order to stably collect sounds generated from the distance while suppressing reverb and howling and collects various types of sounds generated from the areas where the cameras are installed and inputs them to the DVR device 300.

The camera 100 and the microphone 200 may be installed separately or one pair of the camera 100 and the microphone 200 or the camera 100 integrally with the microphone 200 may be installed. At least one camera and microphone are installed in the monitoring area to collect the generated sounds and videos.

The DVR device 300 recognizes the video information and the sound information input through the camera 100 and the microphone 200 to classify the sounds for each type and stores the videos where the specific sounds are generated and accesses only the corresponding stored videos and provides them to the output device 400 when the search of the videos for the specific sounds is requested from the user.

The output device 400 includes a display and a speaker, which outputs only the specific sounds applied to the DVR device 300 and the videos matched with the specific sounds, such that the user can watch them.

The DVR device 300 is configured to include a sound video recorder unit 310, a sound recognizing unit 320, an video managing unit 330, a sound video file storage unit 340, a database 350, a sound video searching unit 360, a sound video display managing unit 370.

The sound video recorder unit 310 simultaneously receives the sound video information from the camera 100 and the microphone 200 up to 16 channels or 32 channels within the channel allowed by the DVR device 300.

When the video and sound information input from the camera 100 and the microphone 200 is an analog signal, the sound video recorder unit 310 converts them into a digital signal.

The sound recognizing unit 320 analyzes sound data that are converted and applied into digital signals in the sound video recorder unit 310 and performs endpoint detection thereon and classifies a sound type through a sound recognizing algorithm and when the classified sound type are recognized as the specific sound, transmits time information corresponding to a time point when the endpoint is detected to the video managing unit 330 and the sound video file storage unit 340.

The sound recognizing unit 320 receives sound data input through the microphone 110 and when the specific sounds are sensed in the sound data, stores the sound type and positional information on the video where the sounds are generated in a database.

The sound recognizing method of the sound recognizing unit 320 determines how much the currently input sounds are similar to the past sounds stored in the database by various pattern classification algorithms such as a dynamic time warping (DTW), a hidden Marcov model (HMM), an artificial neural network (ANN), a support vector machine (SVM), a fuzzy, and so on, thereby determining the most similar sound type.

As one example, the sound input from the microphone 100 is recognized by detecting the endpoint using a zero crossing rate (ZCR) and energy, extracting features by using a linear predictive coding (LPC) method, a mel frequency cepstral coefficient (MFCC) method, etc., and determining the most similar sound type by using only one or at least two of the pattern classifying algorithms such as the dynamic time warping (DTW), the hidden Marcov model (HMM), the artificial neural network (ANN), the support vector machine (SVM), the fuzzy, and so on.

As another example, the sound recognizing unit 320 uses a sound recognizing chip, thereby making it possible to perform a sound recognizing function. In other words, in the case of the digital video recorder system using the DVR card, the sound recognizing chip may be inserted into the DVR card having an audio input terminal and a sound recognizing card configured to include the audio input terminal and the sound recognizing chip may be inserted into a main board. In this case, the sound recognizing unit 320 receives values for the sound type and stores the corresponding sound type and the video range information where the sounds are generated in the database, thereby making it possible to perform the video searching function by using the specific sound.

The video managing unit 330 manages the general video recording and the recording of the range where the specific sounds are generated and manages the general video recording by classifying it into the motion recognizing recording and the entire range recording. Further, when the sound type and the time range information transferred from the sound recognizing unit 320 is recorded in the DVR, they are displayed like a sound waveform.

The sound video file storage unit 340 generates the video range where sounds are generated as a file and stores it in the database 350 and classifies and stores it to be able to search the general video recording file and the video for each specific sound.

The sound video file storage unit 340 stores the general video recording file in an video DB 351 of the database 350, stores the video file where the sound are generated in a sound video DB 352, and stores the video file information for each sound type in a sound video information DB 353.

When the sound video file storage unit 340 is set so that the video is stored over then entire range, it stores only the range information where each sound is generated in one video file to store several sound files in one video file or store one sound information file one video file so that one video file can hold only the range information where each sound is generated.

In addition, when the sound recognition is set, the sound video file storage unit 340 sequentially generates the video files for each range where the sounds are recognized to generate and store one video file per one sound file in pair.

The sound video file storage unit 340 synchronizes the video and sound input through the camera and the microphone and compresses them and then stores them in the video DB 351 or the sound video DB 352.

The sound video searching unit 360 receives a sound keyword, a sound type, and tag information all of which are requested by the user and searches the corresponding sound video stored in the database 350 through the sound video file storage unit 340.

As described above, since the video file information for each sound keyword is stored in the sound video information DB 353, the sound video searching unit 360 searches the position of the corresponding file by using the video file information and accesses the corresponding file through the sound video DB 353.

In addition, the sound video searching unit 360 uses the video file path information and the time range information stored in the sound video information DB 353 to bring the video range information where sounds are generated on the video DB 351 or bring the path information on the video file where the sounds are generated stored in the sound video DB 352.

The sound video display managing unit 370 can provide an interface so that the user can watch the video searched through the sound video searching unit 360, search the sound video file for each date when providing a function of searching videos and using a time searching unit, search a period according to the sound type, the sounds, and the keywords when using a unit of searching the sound type, and search the tags.

In addition, when watching the sound video file, the sound video display managing unit 370 provides a function of seeing only the videos, a function of watching the video and the sound separately, and a function of mixing and watching the video and the sound.

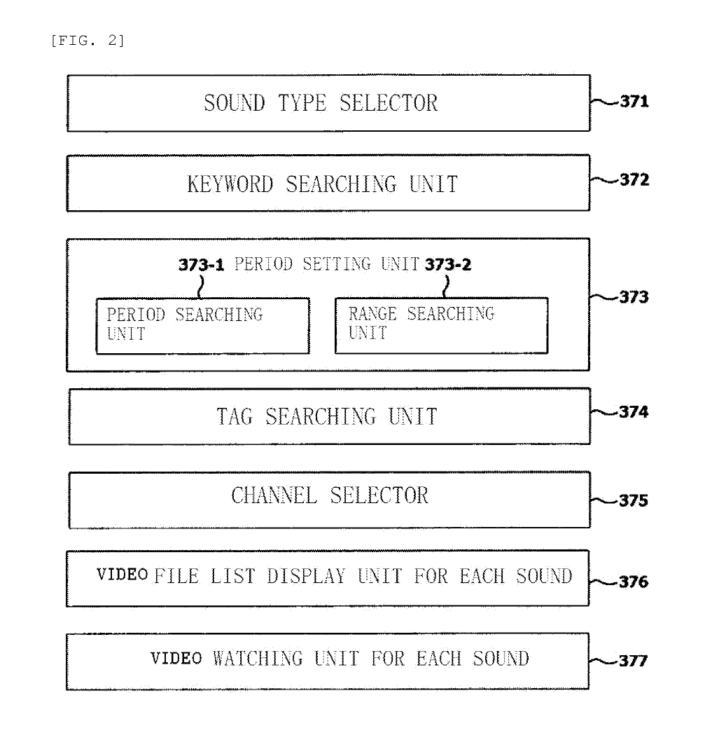

FIG. 2 is a diagram showing a detailed configuration of a sound video display managing unit in the digital video recorder system according to the exemplary embodiment of the present invention.

The sound video display managing unit 370 is configured to include a sound type selector 371, a keyword searching unit 372, a period setting unit 373, a tag searching unit 374, a channel selector 375, an video file list display unit for each sound 376, and an video watching unit for each sound 377.

The sound type selector 371 serves to execute the video searching requested by the user through the sound type selection.

The sound type collected according to the installation place of the digital video recorder system according to the present invention is very variously classified, such that these sounds can be selected.

For example, when the digital video recorder system is installed in an underground parking lot, a road, a tunnel, etc., it collects sounds such as horn, collision, sliding, scratch, tapping, fire, explosion, scream, water leaking, etc., are collected so that it can classify and select these sounds. When the digital video recorder system is installed in a zoo, it collects sounds such as lion, tiger, gorilla, chimpanzee, orangutan, parrot, penguin, etc., so that it can classify and select them. When the digital video recorder system is installed in a pet dog café, it collects a hungry sound, a dog's barking sound to a stranger, a fighting sound, a crying sound, etc. so that it can classify and select them.

Briefly arranging them, they are classified as described in the following Table 1.

TABLE 1

| Underground | | |
|---|---|---|
| parking lot | Zoo | Pet dog cafe |
| horn, collision, | lion, tiger, | hungry sound, dog's |
| sliding, scratch, | gorilla, | barking sound to |
| tapping, fire, | chimpanzee, | stranger, fighting |
| explosion, scream, | orangutan, | sound, crying |
| water leaking, | parrot, penguin, | sound, etc. |
| etc. | etc. | |

The keyword searching unit 372 serves to execute the searching of the specific video through the input of the character keyword.

Since the sound related video information is stored in the sound video information DB 353 in an XML format shown in the following Table 2, an XML script includes the video file information for each sound type in the following Table 2, and thus, serves to rapidly search the corresponding video file by knowing only the sound type.

The video file can represent both the sound generating time and the sound ending time as described below and is generated for each video range where sounds are generated.

TABLE 2

```
< FILE_INFO >
    <ALARM>
        A01_20090123113012123_20090123113016589.avi
    </ALARM >
    <COLLISION >
        A02_20090123113145012_20090123113145625.avi
    </COLLISION >
    <BRAKE>
        A03_20090123114528337_20090123114531050.avi
    </BRAKE >
</ FILE_INFO >
```

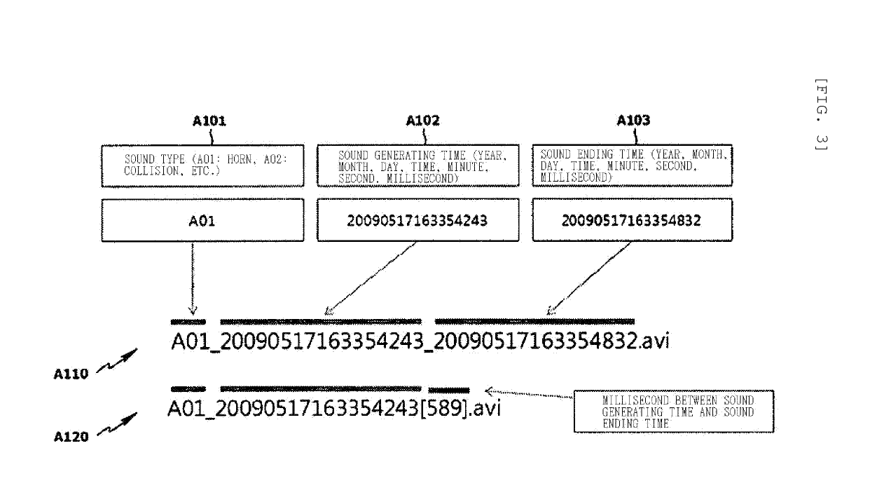

In addition, the video file can represent the time between the sound generating time and the sound ending time in a millisecond as shown in FIG. 3 and is generated for each video range where sounds are generated.

TABLE 3

```
< FILE_INFO >
    <ALARM>
        A01_20090123113012123[4466].avi
    </ALARM >
    <COLLISION >
        A02_20090123113145012[613].avi
    </COLLISION >
    <BRAKE>
        A03_20090123114528337[713].avi
    </BRAKE >
</ FILE_INFO >
```

The following table 4, which represents an example where various sound information is recorded in one video file, includes information on date and time when the video file is generated and includes the sound generated from the corresponding video file and information on the time when the corresponding sounds are generated.

As a result, the user can know when the specific sounds are generated in the video file and reproduce the video by moving to the time range, thereby making it possible to watch the video where the corresponding sounds are generated.

TABLE 4

```
< FILE_INFO >
  <Movie
  name=Car20090131113012000.avi
  Date=2009-01-31
  Time=11:30:12.000></Movie>
  <SoundCategory>
    <ALARM >
      2009.01.23.11:30:12.123[4466]
    </ALARM >
    <COLLISION >
      2009.01.23.11:31:45.012[613]
    </COLLISION >
    <BRAKE >
      2009.01.23.11:45:28.337[713]
    </BRAKE >
  </SoundCategory>
</ FILE_INFO >
```

The period setting unit 373 serves to search the information selected or input from the sound type selector 371 and the keyword searching unit 372 for each specific range.

The period setting unit 373 is classified into a period searching unit 373-1 and a period searching unit 373-2. The range searching unit 373-1 serves to search the video information for each time by selecting year/month/day and the range searching unit 373-2 serves to search the corresponding video by selecting year/month/day corresponding to the start and end of the specific range.

The tag searching unit 374 represents hour/minute/second when the sounds are generated for each camera by a graph and the sound type is represented on the graph representing “second” in a text form, thereby making it possible to easily search whether any sounds are generated in the corresponding second range.

The channel searching unit 375 serves to designate the video inputting camera during a process of searching the videos for each sound.

The video file list display unit for each sound 376 may arrange the information searched through the above-mentioned sound type selector 371, the keyword searching unit 372, and the period setting unit 373 for each sound type and each date and represent them as described in the following Table 5 and represents year/month/day/hour/minute/second/millisecond when the videos are stored, the time when the sounds are generated (millisecond unit), the sound type.

TABLE 5

20091109 01:11:09.023-01:11:09:159 [137, collision]
20091109 01:23:12.001-01:23:12:300 [300, sliding]
20091109 01:29:45.222-01:29:45:358 [136, brake]
20091109 01:35:29.056-01:35:29:156 [101, warning
calls]
20091109 01:37:30.183-01:37:30:194 [012, warning
calls]
20091109 01:37:32.251-01:37:32:350 [100, overspeed]
20091109 01:43:02.063-01:43:02:177 [115, horn]

The video watching unit for each sound 377, which is a unit representing the video information stored for each sound, outputs the videos for the range where the specific sounds are generated or simultaneously outputs the video and the sound, thereby making it possible to watch the video and the sound.

FIG. 3 is a diagram illustrating a configuration of a file information structure generated from the digital video recorder system according to the exemplary embodiment of the present invention.

FIG. 3 shows an example where the video file for each sound is stored in the sound video DB 352 based on time. The video file for each sound is configured to represent sound type A101 such as horn A01, collision A02, etc., sound generating time A102 determined by year, month, day, hour, minute, and millisecond, and sound ending time A103 determined in year, month, day, hour, minute, second, and millisecond in the file name of the video file for each sound.

In this case, the generated video file is configured to include the sound type and the information on the sound generating time and the sound ending time (A110) and to represent the difference between the sound generating time and the sound ending time in a millisecond unit (A120).

For example, if the horn sound of the car starts at 16:33:54, 243 milliseconds, May 17, 2009 and ends 16:33:54, 832 milliseconds, May, 17, 2009, the video file generating the corresponding sounds are stored by a name (A110) called A01_{—}20090517163354243_{—}20090517163354832.avi.

In addition, since the difference between the sound generating time and the sound ending time may be represented by millisecond, the video file with the corresponding sound is stored by a name (A120) called A01_{—}20090517163354243[589].avi.

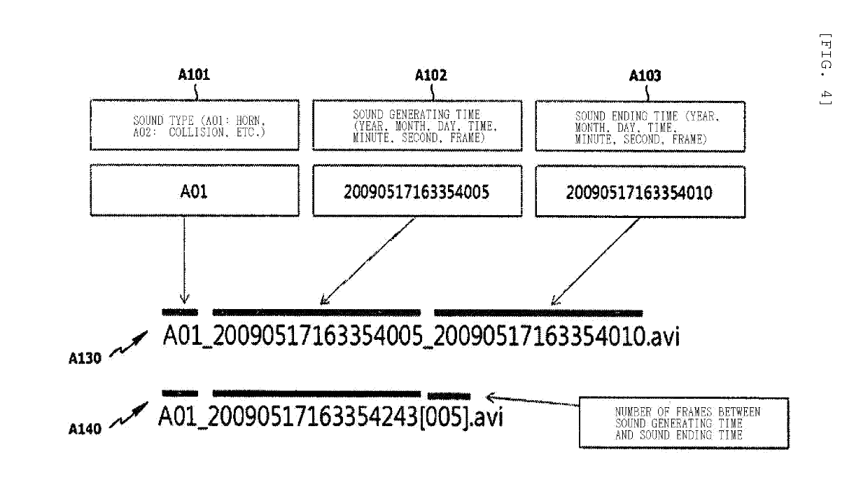

FIG. 4 is a diagram showing another example of a file information structure generated from the digital video recorder system according to the exemplary embodiment of the present invention.

FIG. 4 shows an example where the video file for each sound is stored in the sound video DB 352 based on a frame unit. The video file for each sound is configured to represent sound type A101 such as horn A01, collision A02, etc., sound generating time A102 determined by year, month, day, hour, minute, and second, and sound ending time A103 determined in year, month, day, hour, minute, second, and second in the file name of the video file for each sound (A130) and is configured to represent the difference between the sound generating time and the sound ending time in the number of frames (A140).

When the video files for each sound are stored the number of frames, it is associated with the physical storing data. For example, when the number of frames is 10 frames per second, the video data are continuously stored 10 times per second.

Therefore, if the horn sound of the car starts at 16:33:54, 5 frames, May 17, 2009 and ends 16:33:54, 10 frames, May, 17, 2009, the video file where the corresponding sounds are generated is stored by a name (A130) called A01_{—}20090517163354005_{—}20090517163354010.avi.

In addition, since the difference between the sound generating time and the sound ending time may be represented by the number of frames, the video file with the corresponding sound is stored by a name (A140) called as A01_{—}20090517163354243[005].avi.

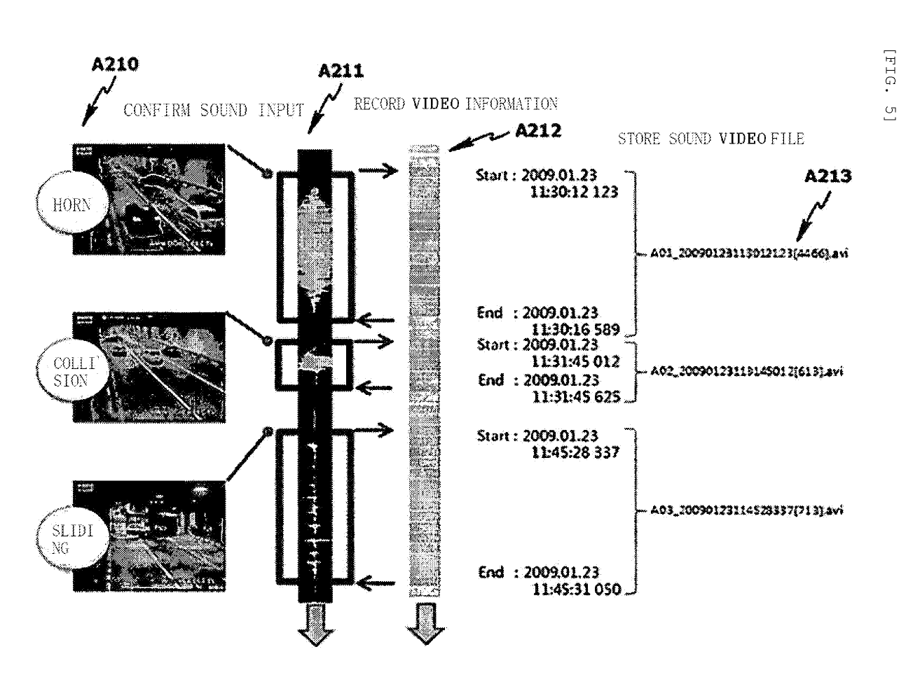

FIG. 5 is a diagram showing a process of storing a sound video file in the digital video recorder system according to the exemplary embodiment of the present invention.

In the state where the videos are input from the camera 100 (A210), if it is recognized that the specific sounds such as horn, collision, sliding, etc., are generated from the microphone 200 in the specific time range (A211), the video information in the range where the corresponding sounds are generated (A212) and the sound video file (A212) is generated by the time or the number of frames, including the sound type and the sound generating time and the sound ending time, and is stored in the database.

For example, when the specific sounds, for example, the generation of the horn sound is sensed at 11:30:12, 123 milliseconds, Jan. 23, 2009, the storing of the video starts in the range where the sounds are generated and when the horn sound ends at 11:30:16, 589 milliseconds, Jan. 23, 2009, the storing of the video ends according to the generation of the horn sound and then, the sound video file is generated and stored.

In this case, since the difference between the sound generating time and the sound ending time may be represented by a millisecond unit or the number of frames, the file name is generated as A01_{—}20090123113012123_{—}20090123113016589.avi or A01_{—}20090123113012123[4466].avi.

As another example, when the specific sounds, for example, the generation of the collision sound is sensed at 11:31:45, 012 milliseconds, Jan. 23, 2009, the storing of the video starts in the range where the sounds are generated and when the collision sound ends at 11:31:45, 625 milliseconds, Jan. 23, 2009, the storing of the video ends in the range where the collision sound is generated and then, the sound video file is generated and stored.

In this case, since the difference between the sound generating time and the sound ending time may be represented by a millisecond unit or the number of frames, the file name is generated and stored as A02_{—}20090123113145012_{—}20090123113145625.avi or A02_{—}20090123113145012[613].avi.

As another example, when the specific sounds, for example, the generation of the sliding sound is sensed at 11:45:28, 337 milliseconds, Jan. 23, 2009, the storing of the video starts in the range where the sounds are generated and when the sliding sound ends at 11:45: 31, 050 milliseconds, Jan. 23, 2009, the storing of the video ends in the range where the sliding sound is generated and then, the sound video file is generated and stored.

In this case, since the difference between the sound generating time and the sound ending time may be represented by a millisecond unit or the number of frames, the file name is generated and stored as A03_{—}20090123114528337_{—}20090123114531050.avi or A03_{—}20090123114528337[713].avi.

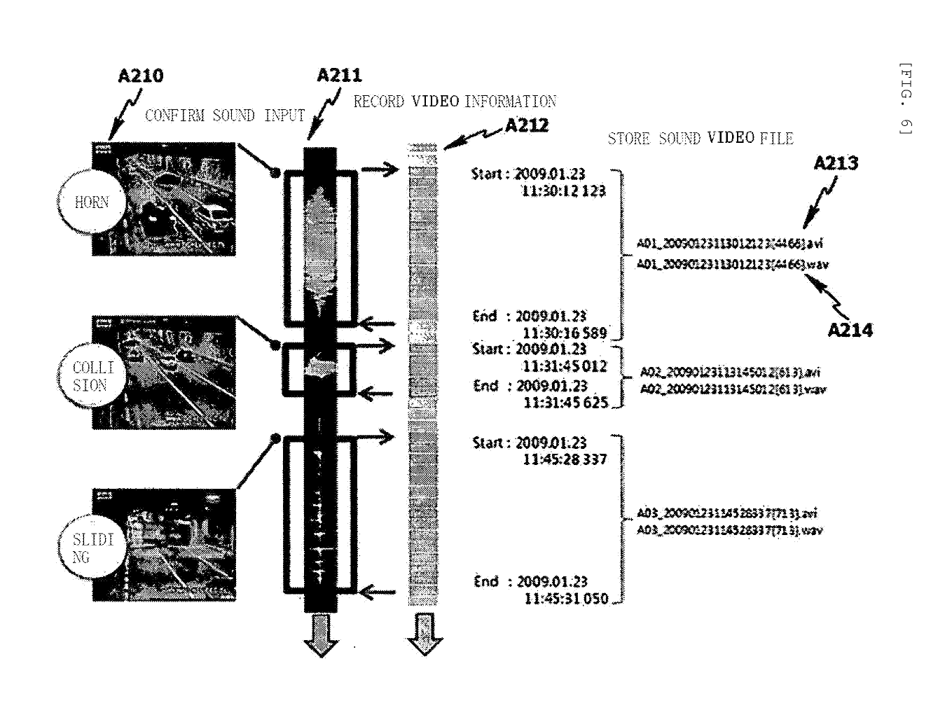

FIG. 6 is a diagram showing a process of storing a sound video file and a sound file in the digital video recorder system according to the exemplary embodiment of the present invention.

In the state where the videos are input from the camera 100 (A210), if it is recognized that the specific sounds such as horn, collision, sliding, etc., are generated from the microphone 200 in the specific time range (A211), the video information in the range where the corresponding sounds are generated (A212) and the sound video file (A213) and the sound file are simultaneously generated by the time or the number of frames, including the sound type and the sound generating time and the sound ending time, and is stored in the database.

Therefore, when the videos are searched by using the specific sound as the keyword, the sound of the corresponding video may be driven.

For example, when the specific sounds, for example, the generation of the horn sound is sensed at 11:30:12, 123 milliseconds, Jan. 23, 2009, the video starts to be stored in the range where the sounds are generated and when the horn sound ends at 11:30:16, 589 milliseconds, Jan. 23, 2009, the storing of the video ends according to the generation of the horn sound and then, the sound video file and the sound file are generated and stored.

In this case, since the difference between the sound generating time and the sound ending time may be represented by a millisecond unit or the number of frames, the sound video file is generated as A01_{—}20090123113012123_{—}20090123113016589.avi or A01_{—}20090123113012123[4466].avi.

The sound file name is generated as A01_{—}20090123113012123_{—}20090123113016589.wav or A01_{—}20090123113012123[4466].way.

For example, when the specific sounds, for example, the generation of the collision sound is sensed at 11:31:45, 012 milliseconds, Jan. 23, 2009, the storing of the video starts in the range where the sounds are generated and when the collision sound ends at 11:31:45, 625 milliseconds, Jan. 23, 2009, the storing of the video ends according to the generation of the collision sound and then, the sound video file and the sound file are generated and stored.

In this case, since the difference between the sound generating time and the sound ending time may be represented by a millisecond unit or the number of frames, the sound video file is generated as A02_{—}20090123113145012_{—}20090123113145625.avi or A02_{—}20090123113145012[613].avi.

For example, when the specific sounds, for example, the generation of the sliding sound is sensed at 11:45:28, 337 milliseconds, Jan. 23, 2009, the video starts to be stored in the range where the sounds are generated and when the sliding sound ends at 11:45:31, 050 milliseconds, Jan. 23, 2009, the storing of the video ends according to the generation of the sliding sound and then, the sound video file and the sound file are generated and stored.

In this case, since the difference between the sound generating time and the sound ending time may be represented by a millisecond unit or the number of frames, the sound video file is generated as A03_{—}20090123114528337_{—}20090123114531050.avi or A03_{—}20090123114528337[713].avi.

The sound video file name is generated as A03_{—}20090123114528337_{—}20090123114531050.avi or A03_{—}20090123114528337[713].avi.

As described above, if the sound video file and the sound file are simultaneously generated and stored, it is advantageous that the sound of the corresponding video can be reproduced when the video is searched by the specific keyword.

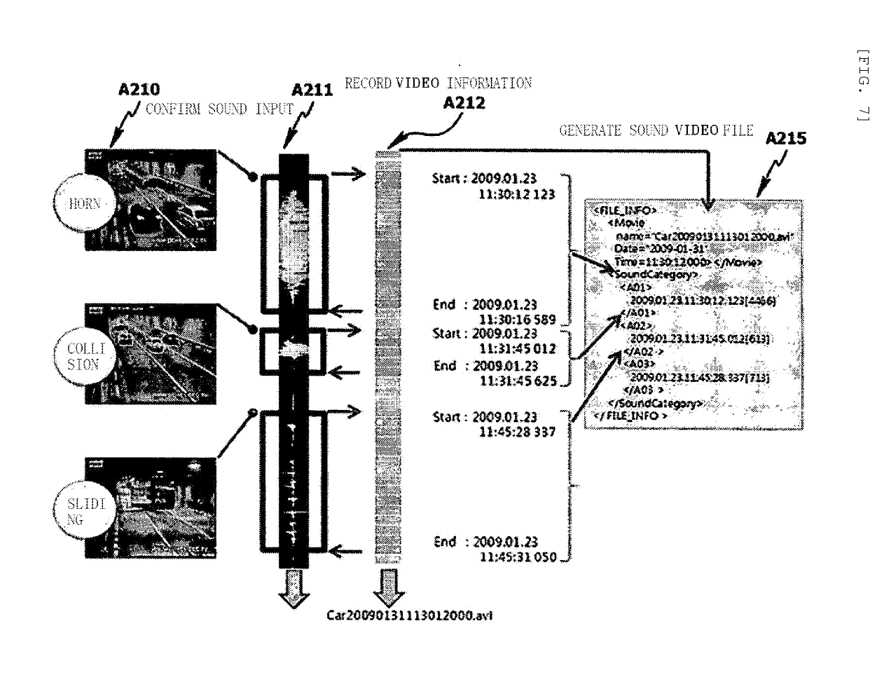

FIG. 7 is a diagram showing a process of generating a sound video information DB in the digital video recorder system according to the exemplary embodiment of the present invention.

In the state where the videos are input from the camera 100 (A210), if it is recognized that the specific sounds such as horn, collision, sliding, etc., are generated from the microphone 200 in the specific time range (A211), the video information in the range where the corresponding sounds are generated (A212) and the sound video information A215 is generated, including the sound type and the sound generating time and the sound ending time and is stored in the database.

In this case, all the range information where the sounds are generated is recorded in one video file, such that the position of the video where the specific sounds are generated can be rapidly searched.

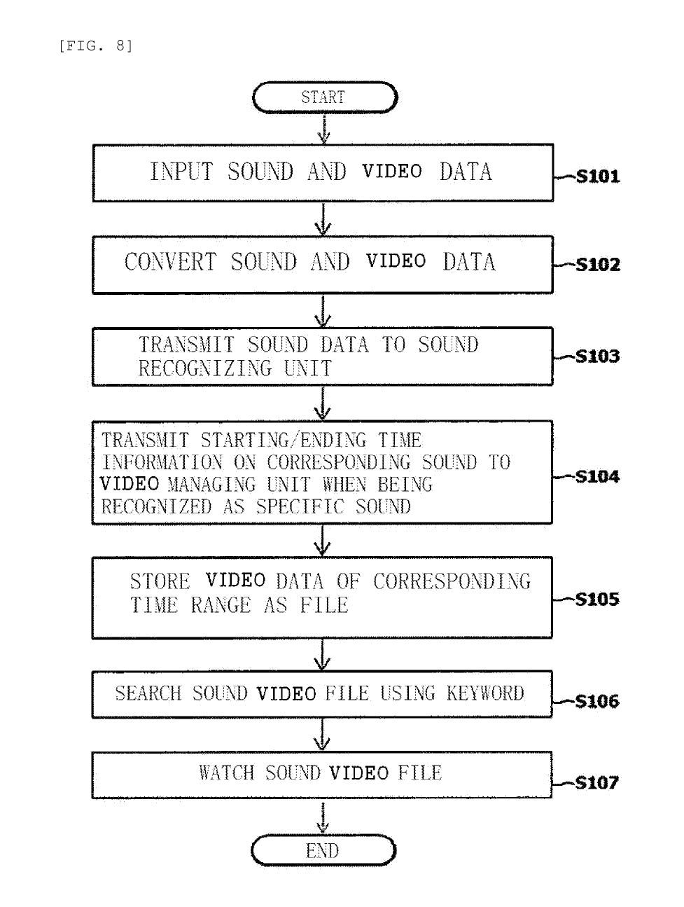

FIG. 8 is a diagram schematically showing an operational process of the digital video recorder system according to an exemplary embodiment of the present invention.

When the sound in the analog signal form and the video data are input to the sound video recorder unit 310 from the camera 100 and the microphone 200 (S101), the sound video recorder unit 310 converts the corresponding sound and the video data in the analog form into the digital signal (S102) and transmits the video data to the video managing unit 330 and transmits the sound data to the sound recognizing unit 320 (S103).

Therefore, the video managing unit 330 manages all the videos collected in the camera 100 independent from the sound information and stores them in the video DB 351 of the database 350 as a file.

Further, the sound recognizing unit 320 analyzes the sound data transmitted from the sound video recorder unit 310 and when the sound data are recognized as the specific sound, transmits the information on the starting and ending time of the corresponding sound to the video managing unit 330 (S104).

In this case, the video managing unit 330 transmits the video information corresponding to the starting and ending positions of the specific sound to the sound video file storage unit 340 according to the information provided from the sound recognizing unit 320 and the sound video file storage unit 340 converts only the video corresponding to the starting and ending time of the specific sound into the time based moving pictures in a format shown in FIG. 3 and stores them in the sound video DB 352 of the database 350 and stores the sound type and the time information when sounds are generated in the sound video information DB 353 of the database 350 (S105).

Thereafter, when the search of the sound keywords or the sound video file for each sound is requested from the user, the sound video searching unit 360 searches the database 350 (S106) to extract the corresponding video file and then, reproduces the sound video sound through the sound video display managing unit 370 (S107).

In order to reproduce the sound video file, the sound video display managing unit 370 transmits the corresponding file information to the output device 400 to reproduce only moving pictures range corresponding to the generating time and completing time for each sound stored in the sound video information DB 353, such that the user can watch the reproduced moving pictures.

The above process is an example of the case where the generation of the sound video file is made based on the time for the starting time and ending time of the specific sound.

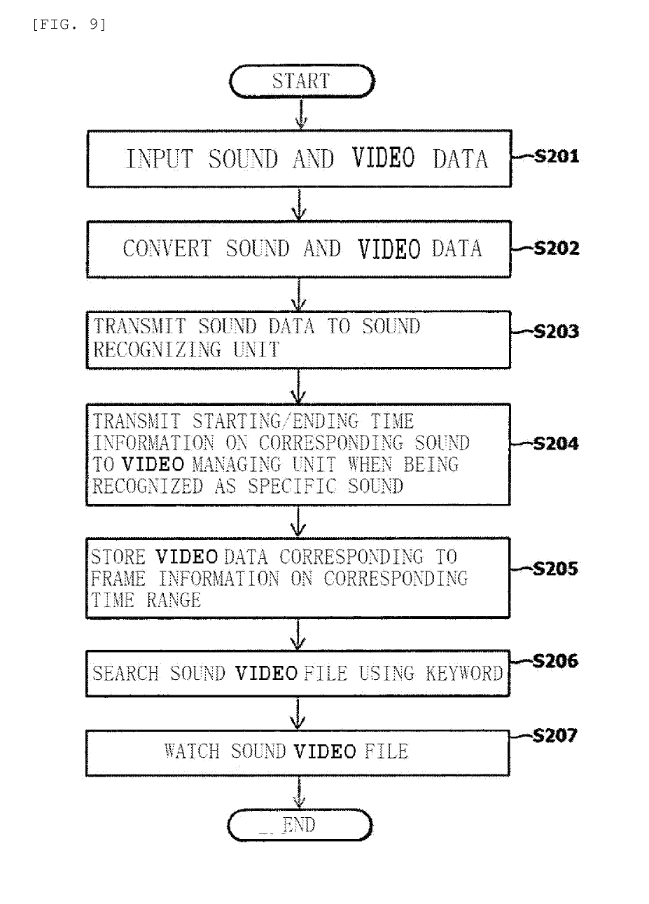

FIG. 9 is a diagram schematically showing another example of an operational process of the digital video recorder system according to an exemplary embodiment of the present invention.

When the sound in the analog signal form and the video data are input to the sound video recorder unit 310 from the camera 100 and the microphone 200 (S201), the sound video recorder unit 310 converts the corresponding sound and the video data in the analog form into the digital signal (S202) and transmits the video data to the video managing unit 330 and transmits the sound data to the sound recognizing unit 320 (S203).

Therefore, the video managing unit 330 manages all the videos collected in the camera 100 independent from the sound information and stores them in the video DB 351 of the database 350 as a file.

Further, the sound recognizing unit 320 analyzes the sound data transmitted from the sound video recorder unit 310 and when the sound data are recognized as the specific sound, transmits the information on the starting and ending time of the corresponding sound to the video managing unit 330 (S204).

In this case, the video managing unit 330 transmits the video information corresponding to the starting and ending positions of the specific sound to the sound video file storage unit 340 according to the information provided from the sound recognizing unit 320 and the sound video file storage unit 340 converts only the video corresponding to the starting and ending time of the specific sound into the video frame based moving pictures in a format shown in FIG. 4 and stores them in the sound video DB 352 of the database 350 and stores the sound type and the time information when sounds are generated in the sound video information DB 353 of the database 350 (S205).

Thereafter, when the search of the sound keywords or the sound video file for each sound is requested from the user, the sound video searching unit 360 searches the database 350 (S206) to extract the corresponding video file and then, reproduces the sound video sound through the sound video display managing unit 370 (S207).

In order to reproduce the sound video file, the sound video display managing unit 370 transmits the corresponding file information to the output device 400 to reproduce only moving pictures range corresponding to the generating time and completing time for each sound stored in the sound video information DB 353, such that the user can watch the reproduced moving pictures.

The above process is an example of the case where the generation of the sound video file is made based on the video frames for the starting time and ending time of the specific sound.

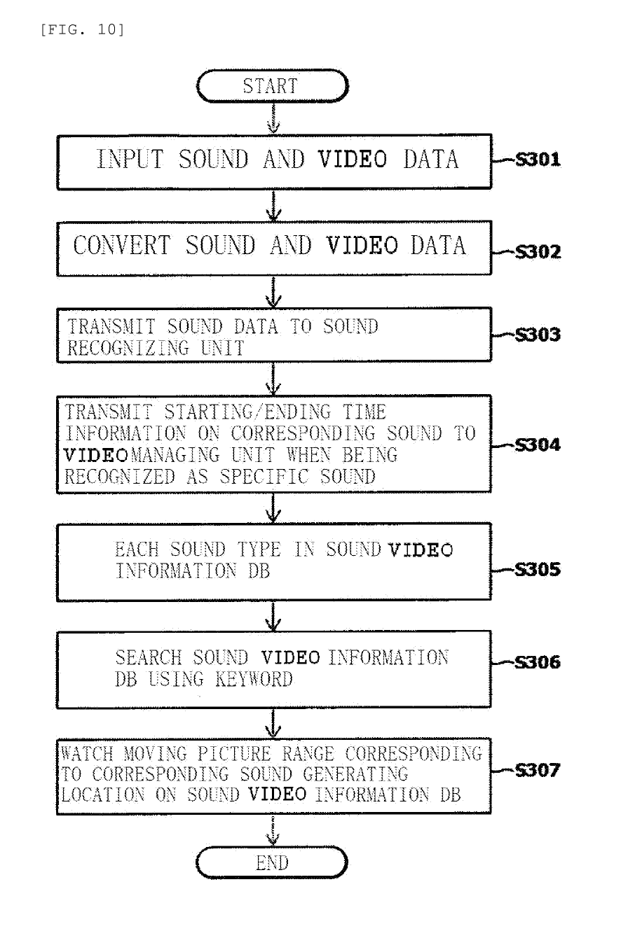

FIG. 10 is a diagram schematically showing still another example of an operational process of the digital video recorder system according to an exemplary embodiment of the present invention.

When the sound in the analog signal form and the video data are input to the sound video recorder unit 310 from the camera 100 and the microphone 200 (S301), the sound video recorder unit 310 converts the corresponding sound and the video data in the analog form into the digital signal (S302) and transmits the video data to the video managing unit 330 and transmits the sound data to the sound recognizing unit 320 (S303).

Therefore, the video managing unit 330 manages all the videos collected in the camera 100 independent from the sound information and stores them in the video DB 351 of the database 350 as a file.

Further, the sound recognizing unit 320 analyzes the sound data transmitted from the sound video recorder unit 310 and when the sound data are recognized as the specific sound, transmits the information on the starting and ending time of the corresponding sound to the video managing unit 330 (S304).

In this case, the video managing unit 330 transmits the range information on the sound generating time and ending time to the sound video file storage unit 340 according to the information provided from the sound recognizing unit 320 and the sound video file storage unit 340 stores the sound video file in the sound video information DB 353 of the database 350 based on one sound video file without classifying the sound video file as shown in FIG. 7.

Thereafter, when the search of the sound video information DB is requested using the sound keyword from the user, the sound video searching unit 360 searches the database 350 (S306) to extract only the moving pictures corresponding to the corresponding sound generating position on the sound video information DB and then reproduce the sound video searched through the sound video display managing unit 370 (S307).

In order to reproduce the sound video file, the sound video display managing unit 370 transmits the corresponding file information to the output device 400 to reproduce only moving pictures range corresponding to the generating time and completing time for each sound stored in the sound video information DB 353, such that the user can watch the reproduced moving pictures.

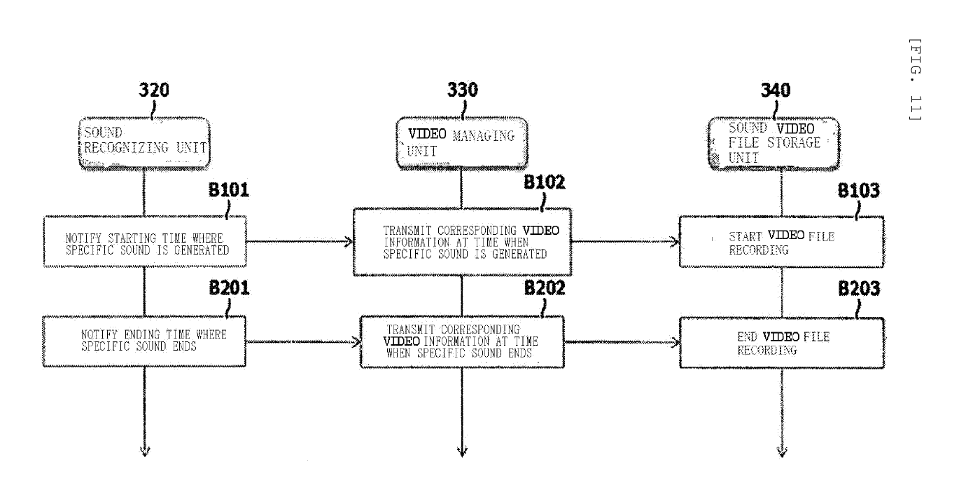

FIG. 11 is a diagram showing a process of storing a video file of a digital video recorder system according to an exemplary embodiment of the present invention and is a diagram showing a process of storing time based video file.

When the sound in the analog signal form and the video data are input to the sound video recorder unit 310 from the camera 100 and the microphone 200 (S101), the sound video recorder unit 310 converts the corresponding sound and the video data in the analog form into the digital signal (S102) and transmits the converted video data to the video managing unit 330 and transmits the sound data to the sound recognizing unit 320.

Therefore, the video managing unit 330 manages all the videos collected in the camera 100 independent from the sound information and stores them in the video DB 351 of the database 350 as a file.

In this case, the sound recognizing unit 320 analyzes the sound data transmitted from the sound video recorder unit 310 and when the generation of the specific sound are recognized, transmits the notification information on the starting time when the specific sounds are generated to the video managing unit 330 (B101).

If the video managing unit 330 extracts only the video information on the time when the specific sounds are generated according to the notification information provided from the sound recognizing unit 320 and transmits it to the sound video file storage unit 340 (B102), the sound video file storage unit 340 starts the recording of the video file of the video where the specific sounds are generated (B103).

As described above, during the process of executing the recording of the video file, when the ending of the specific sound is detected in the sound recognizing unit 320, the notification information at the time when the specific sound ends is transmitted to the video managing unit 330 (B201).

If the video managing unit 330 extracts the video information corresponding to the time when the specific sound ends according to the notification information provided from the sound recognizing unit 320 and transmits it to the sound video file storage unit 340 (B202), the sound video file storage unit 340 ends the recording of the video file of the video where the specific sounds are generated (B203).

Thereafter, the sound video file storage unit 340 generates the file name for the video file where the specific sounds are generated through the process in the format as shown in FIG. 3 and stores the moving pictures in the sound video DB 352 of the database 350 and stores the sound type and the time information when the sounds are generated in the sound video information DB 353.

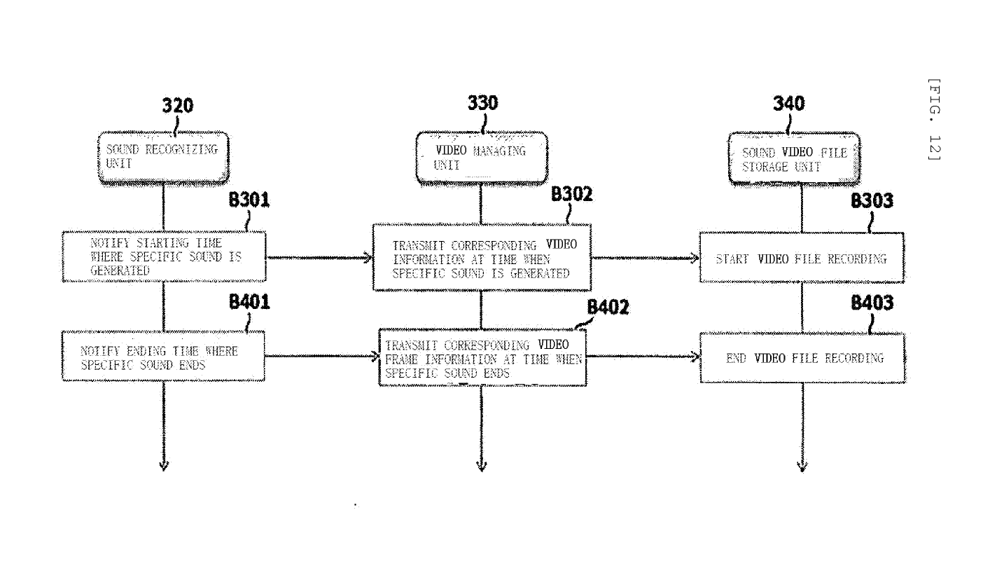

FIG. 12 is a diagram showing another example of a process of storing a video file of a digital video recorder system according to an exemplary embodiment of the present invention and is a diagram showing a process of storing frame based video file.

When the sound in the analog signal form and the video data are input to the sound video recorder unit 310 from the camera 100 and the microphone 200 (S101), the sound video recorder unit 310 converts the corresponding sound and the video data in the analog form into the digital signal (S102) and transmits the converted video data to the video managing unit 330 and transmits the sound data to the sound recognizing unit 320.

Therefore, the video managing unit 330 manages all the videos collected in the camera 100 independent from the sound information and stores them in the video DB 351 of the database 350 as a file.

In this case, the sound recognizing unit 320 analyzes the sound data transmitted from the sound video recorder unit 310 and when the generation of the specific sound are recognized, transmits the notification information on the starting time when the specific sound is generated to the video managing unit 330 (B301).

If the video managing unit 330 extracts only the video information corresponding to the time when the specific sound is generated according to the notification information provided from the sound recognizing unit 320 and transmits it the sound video file storage unit 340 (B302), the sound video file storage unit 340 starts the recording of the video file of the video where the specific sound is generated (B303).

As described above, during the process of executing the recording of the video file, when the ending of the specific sound is detected in the sound recognizing unit 320, the notification information at the time when the specific sound ends is transmitted to the video managing unit 330 (B401).

If the video managing unit 330 extracts only the video information corresponding to the time when the specific sound ends according to the notification information provided from the sound recognizing unit 320 and transmits it to the sound video file storage unit 340 (B402), the sound video file storage unit 340 ends the recording of the video file of the video where the specific sounds are generated (B403).

Thereafter, the sound video file storage unit 340 generates the file name for the video file where the specific sounds are generated through the above-mentioned process based on the video frame in the format as shown in FIG. 4 and stores the moving pictures in the sound video DB 352 of the database 350 and stores the sound type and the time information when the sounds are generated in the sound video information DB 353.

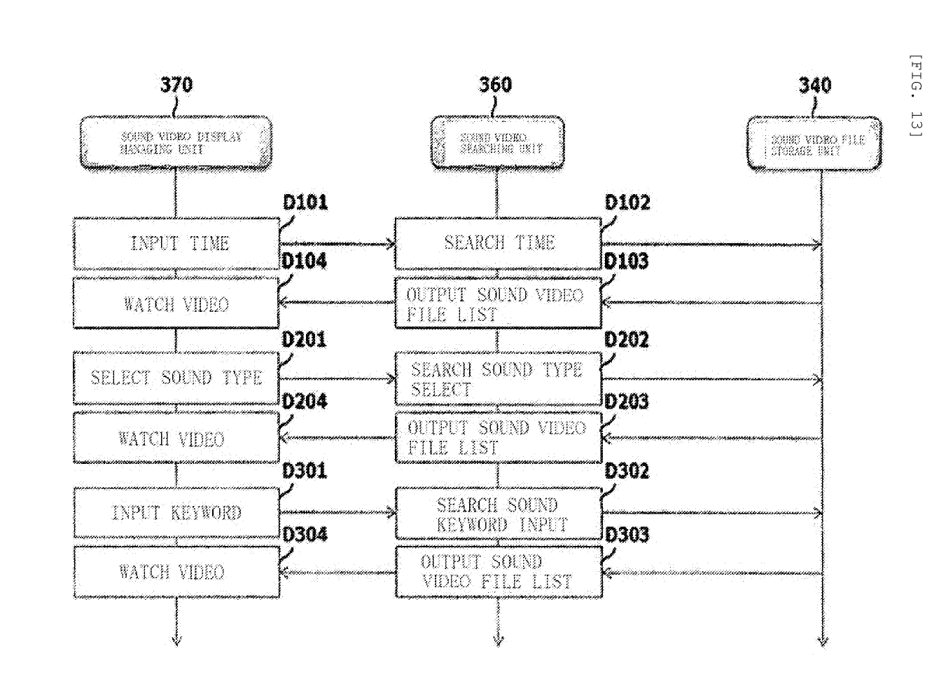

FIG. 13 is a diagram showing a process of searching a sound video file of a digital video recorder system according to an exemplary embodiment of the present invention.

When the sound video display managing unit 370 connected to the user interface detects the input at the specific time when the sound video file is searched, the search request of the sound video file is provided to the sound video searching unit 360 (D101).

The sound video searching unit 360 executes the search of the sound video file at the corresponding time using the keyword to request the sound video file information that is recorded in the sound video file storage unit 340 (D102).

Thereby, when the sound video file storage unit 340 provides the sound video file list stored in the sound video information DB 353 to the sound video searching unit 360 (D103), it extracts the sound video file at the corresponding time stored in the sound video DB 352 and reproduces the extracted sound video file through the output device 400 connected to the sound video display managing unit 370, such that the user can watch the videos where the specific sound are generated (D104).

Further, when the sound video display managing unit 370 connected to the user interface detects the input of the sound type to search the sound video file, the search request of the sound video file is provided to the sound video searching unit 360 (D201).

The sound video searching unit 360 executes the search of the sound video file at the corresponding sound type using the keyword to request the sound video file information that is recorded in the sound video file storage unit 340 (D202).

Thereby, when the sound video file storage unit 340 provides the sound video file list stored in the sound video information DB 353 to the sound video searching unit 360 (D203), it extracts the sound video file at the corresponding time stored in the sound video DB 352 and reproduces the extracted sound video file through the output device 400 connected to the sound video display managing unit 370, such that the user can watch the videos where the specific sound are generated (D204).

Further, when the sound video display managing unit 370 connected to the user interface detects the input of the sound keyword to search the sound video file, the search request of the sound video file is provided to the sound video searching unit 360 (D301).

The sound video searching unit 360 executes the search of the sound video file using the sound keyword to request the sound video file information that is recorded in the sound video file storage unit 340 (D302).

Thereby, when the sound video file storage unit 340 provides the sound video file list stored in the sound video information DB 353 to the sound video searching unit 360 (D303), it extracts the sound video file at the corresponding time stored in the sound video DB 352 and reproduces the extracted sound video file through the output device 400 connected to the sound video display managing unit 370, such that the user can watch the videos where the specific sound are generated (D304).

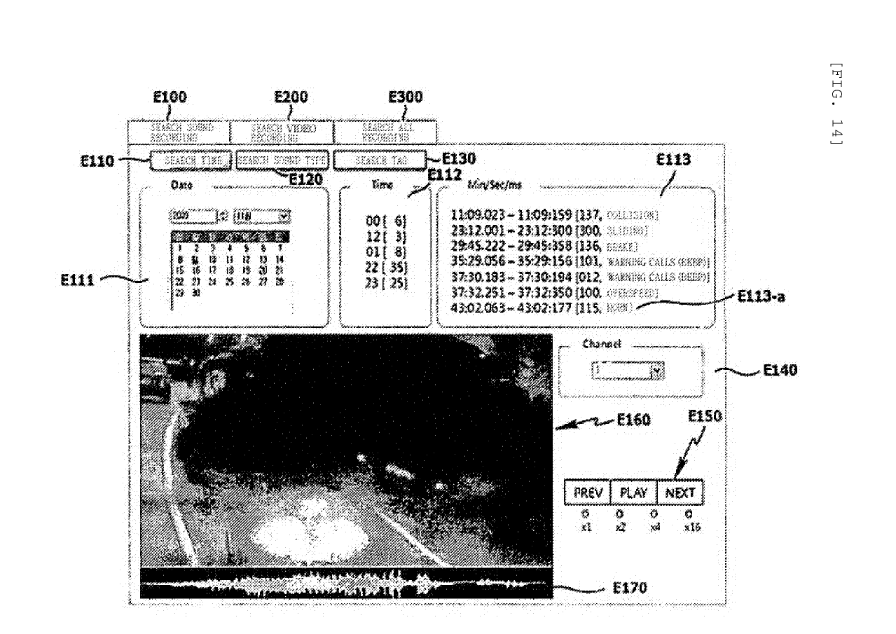

FIG. 14 is a diagram showing a screen for searching a sound video file of a digital video recorder system according to an exemplary embodiment of the present invention.

When the time search is selected in the screen of the sound video display managing unit connected to the user interface, as shown, a button E100 selecting the sound recording search, a button E200 selecting the video recording search, a button E300 selecting the recording search or the recording search of the entire range, a button E110 selecting the time search for the sound video file, a button E120 selecting the search of the sound type for the sound video file, a button E130 selecting the tag search by selecting the channel or the camera to which the videos are input, a button E111 selecting date to be searched when the time search is selected in the menu, a button E112 selecting the time to be searched, a button E113 selecting the sound video file, a button E140 selecting the camera inputting the videos, and a button E150 executing the reproduction of the searched sound video file are provided.

The button is connected to the user interface in a mouse, a touch panel, or the other schemes, thereby executing the selection of the button.

The operation of executing the time search on the sound video file through the screen of the sound video display managing unit having the above-mentioned structure is as follows.

When the sound recording search button E100 and the time search button E110 are selected, the button E111 selecting date to be searched is activated and thus, when ‘year’, ‘month’, and ‘day’ to be searched are selected, the time information storing the videos corresponding to the corresponding date is activated in the selected time select button E112. Thereby, when ‘time’ to be searched is selected, the sound video file information generated in the selected ‘time’ is displayed E113.

In the screen, when ‘time’ activated by red is 01[8], 01 is one o'clock, [8] means the fact that 8 sound video files are recorded in one o'clock range.

Each sound video file is represented by 11:09.023-11:09:159[137, collision] and it can be appreciated that this is the file information where the collision sounds are generated for a period of 137 milliseconds within 11:9:23 to 11:09:159.

When one of the sound video file lists is clicked, the video file for the specific sounds such as the stored collision, sliding, brake, warning calls (beep), horn, etc., is reproduced and displayed (E160) and the waveform of the sound is displayed accordingly (E170).

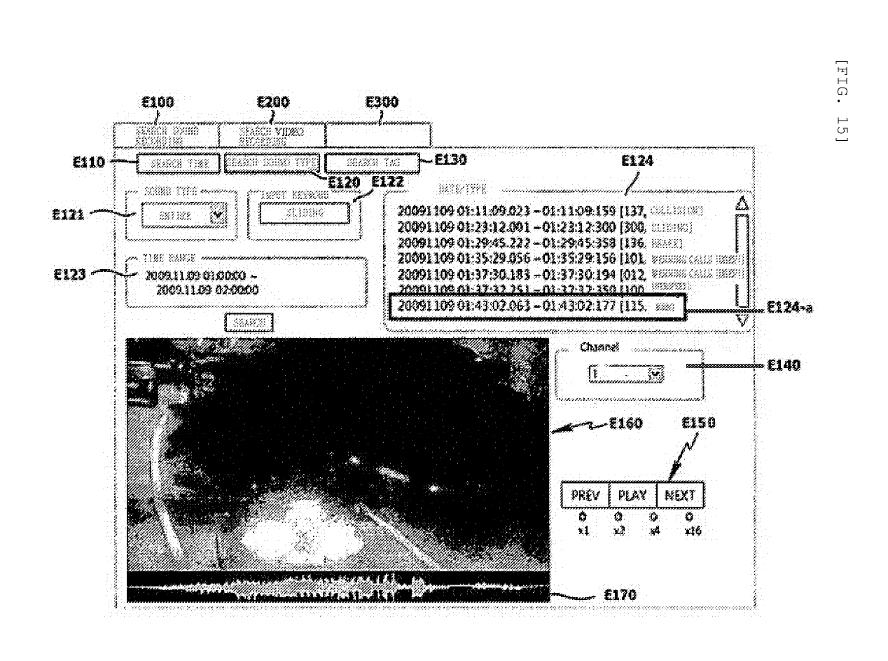

FIG. 15 is a diagram showing another example of a screen for searching a sound video file of a digital video recorder system according to an exemplary embodiment of the present invention.

FIG. 15 is a diagram showing an example of searching the sound video file as the sound type through the screen of the sound video display managing unit.

When the sound recording search button E110 and the sound type search button E120 are selected, a button E120 capable of selecting the sound type is activated. As the sound type, the collision, sliding, brake, overspeed, etc. are previously allocated, such that the sound type to be searched can be selected and if the sound type is selected as ‘entire’ at the time directly inputting the sound keywords, a button E122 capable of directly inputting the keywords are activated.

Further, an input device E123 capable of inputting the time range information where the corresponding sound is generated to the lower end is activated and when the time range information is input, the searching button is activated. Thereby, when the searching button is pressed, the sound video file information list generated in the corresponding time range is output (E124).

In the case of '20091109 01:43:02.063-01:43:02:177 [115, horn] activated by red in the sound video file information, it represents the sound video file where the ‘horn’ sound is generated for 115 milliseconds in 1:43; 2, 63 milliseconds to 1:43:2, 177 milliseconds, Nov. 9, 2009. The detailed structure thereof will be described in detail with reference to FIG. 9A.

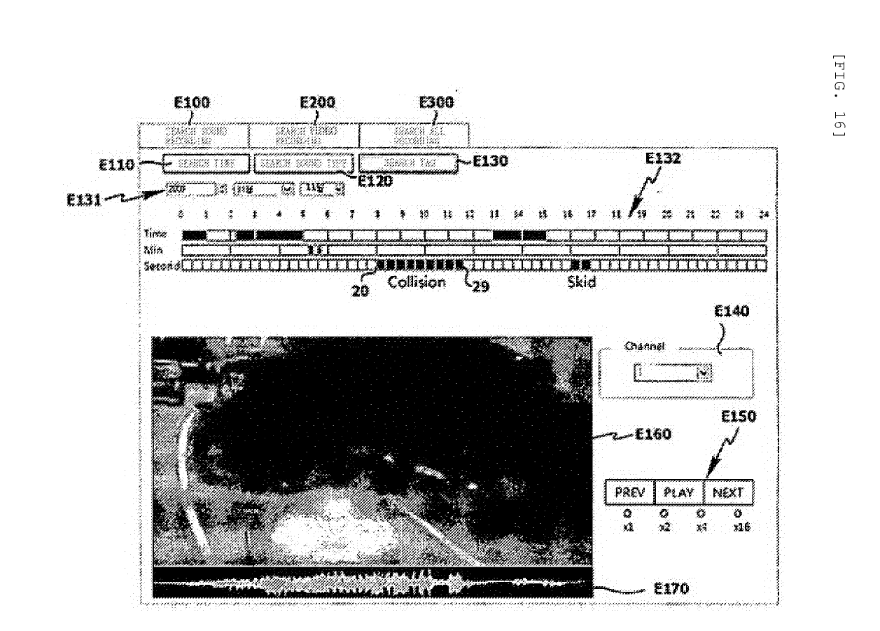

FIG. 16 is a diagram showing still another example of a screen for searching a sound video file of a digital video recorder system according to an exemplary embodiment of the present invention.

FIG. 16 is a diagram showing an example of performing the tag search on the sound video file through the screen of the sound video display managing unit.

The sound recording search button E100 and the tag search button E130 are selected and then, the channel or the camera E140 inputting the videos are selected and when ‘year’, ‘month’, and ‘day’ to search the video file are selected, the information on the video range stored for 24 hours of the selected (camera) is displayed on the screen unit hour/minute/second unit (E132) and the sound type generated in a second range is displayed as a tag.

In FIG. 16, the time unit is displayed to be divided into 24 hours, the minute unit is displayed to be divided into 60 minutes (in FIG. 16, one scale is 5 minutes), and the second unit is displayed to be divided into 60 seconds.

Therefore, as a result of searching the tag, the specific sounds are generated at 2:14, it can be appreciated that the specific sounds generated between 2:14:20 and 2:14:29 may be the collision sound. When the corresponding range is clicked, the stored sound video file is reproduced, which is then displayed on the screen (E160). The waveform information on the stored sound is displayed E170.

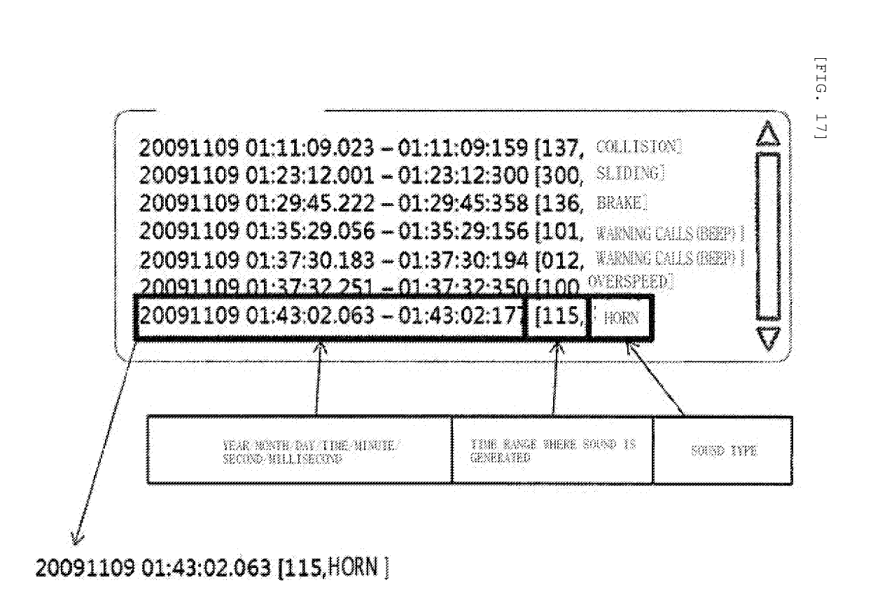

FIG. 17 is a diagram showing a range sound video file list in a digital video recorder system according to an exemplary embodiment of the present invention.

In FIG. 17, in the case of '20091109 01:43:02.063-01:43:02:177[115, horn] of the sound video file information activated by red, it represents the sound video file where the ‘horn’ sound is generated for 115 milliseconds of a range from 1:43; 2, 63 milliseconds to 1:43:2, 177 milliseconds, Nov. 9, 2009.

When the video range information displayed in the sound video file list is played, only the time range where the sound is generated may be played. Further, the video is reproduced earlier by 1 second to 5 seconds than the starting time of the video where the sounds are generated and reproduced earlier by 1 second to 5 seconds than the ending time of the video where the sounds end, such that the videos before and after the time range where the specific sounds are generated are output, thereby making it possible to know before and after situations.

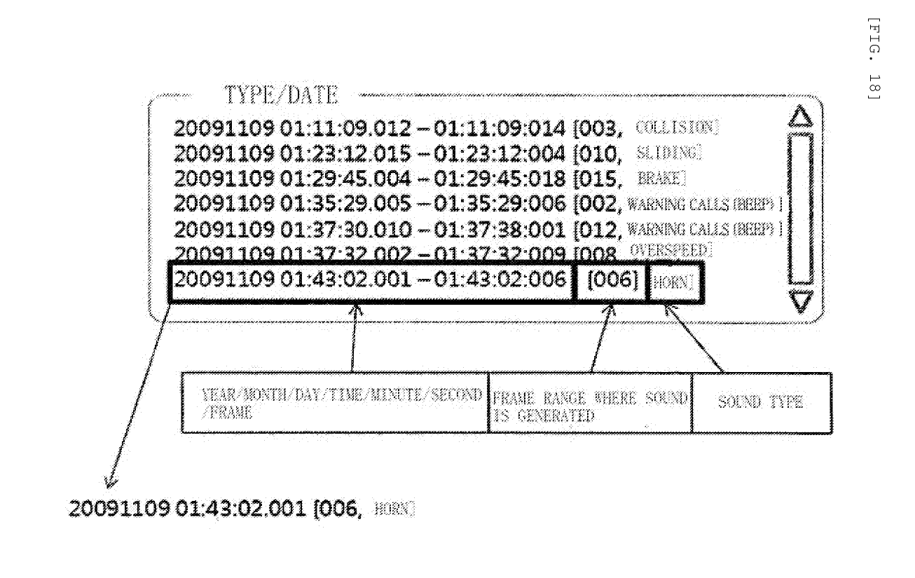

FIG. 18 is a diagram showing another example of a range sound video file list in the digital video recorder system according to an exemplary embodiment of the present invention.

In FIG. 18, in the case of '20091109 01:43:020.001-01:43:02:006[006, horn] of the sound video file information activated by red, it represents the sound video file where the ‘horn’ sound is generated for 6 frames in a range from 1:43; 2, 1 frame to 1:43:2, 6 frames, Nov. 9, 2009.

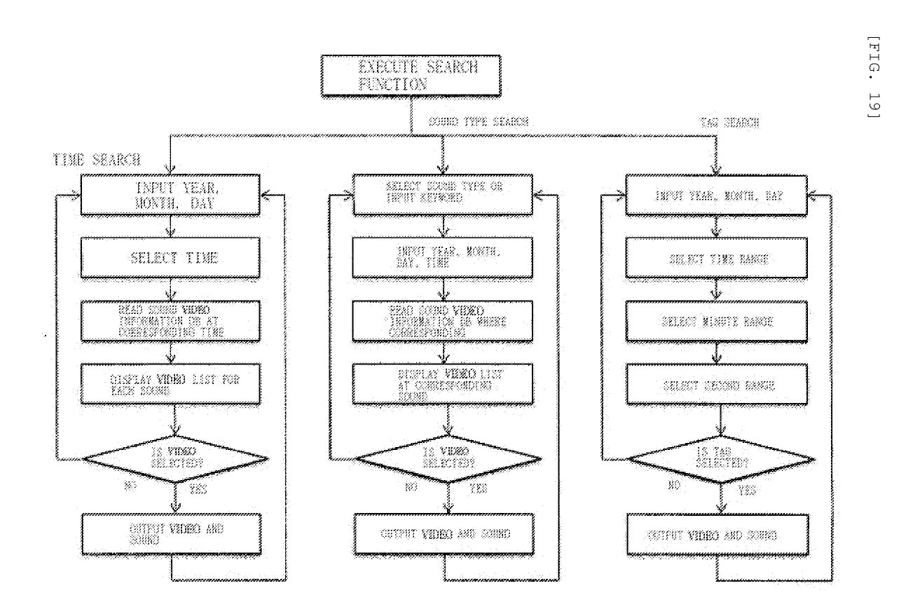

FIG. 19 is a diagram showing a process of performing a search of a sound video file of a digital video recorder system according to an exemplary embodiment of the present invention.

In the case of the time search, when year, month, and day are input and the time is selected, the video list for each sound generated at the corresponding time is read and displayed in the database and when the corresponding video is selected, the video and sound are output.

In the case of the sound type, when the sound type is selected or the sound type is input by the keyword, the video list corresponding to the sound type is read in the database to display the video list and when year, month, day, and time information are further input, the video list generated at the corresponding time is displayed and when the specific videos are selected, the corresponding video and sound are output.

In the case of the tag search, when year, month, and day are selected, the video information generated at the corresponding day is read in the database and is represented by the scale of time unit, minute unit, and second unit and the sound type is represented at the upper end of the scale of the second unit in a text form and when the text (tag) is selected or any location on the range of the scale of the second unit is selected, the corresponding video is output together with sound.

As set forth above, the DVR system according to the exemplary embodiments of the present invention classifies the sound input from the microphone for each type and stores the video and the range information according to the sound to enable the user to rapidly search, reproduce, and analyze the video generating the specific sound, thereby making it possible to conveniently and rapidly search and analyze the videos.

What is claimed is:

1. A digital video recorder system, comprising:
an video recorder unit that records videos in monitoring areas;
a sound input unit that inputs sounds in the monitoring areas;
a DVR device that classifies the sounds for each type by recognizing the sounds in the monitoring areas, stores a recorded video or range information where specific sounds are generated, with the range information consisting of a time or frame information at a point where sound starts generating and a time or frame information at a point where sound stops generating, and accesses the corresponding videos and outputs them to an output device according to the search request of the videos for the specific sounds; and
an output device divided into a display and a speaker, thus outputting videos matching with a specific sound inputted into or transmitted to the DVR device.

2. The digital video recorder system according to claim 1, wherein the sound input unit is applied with any one of a dynamic microphone, a condenser microphone, and a ribbon microphone and is applied with any one of a directional microphone and a non-directional microphone according to directivity.

3. The digital video recorder system according to claim 1, wherein at the video recorder unit and the sound input unit are installed a camera and a microphone separately or in at least one pair or in a form of a camera with a built-in microphone and the monitoring area is installed with at least one pair of the same.

4. The digital video recorder system according to claim 1, wherein the DVR device generates and stores only one sound video file for each sound and reproduces the video file of the range where the specific sounds are generated, in response to the search request.

5. The digital video recorder system according to claim 1, wherein the DVR device records, by the kinds of sounds, the range information where the specific sound are generated and reproduces the video range where the specific sounds are generated according to the search request.

6. The digital video recorder system according to claim 1, wherein the DVR device records the range information where the specific sound is generated for each sound in a time unit and reproduces it earlier by 1 second to 5 seconds than the starting time of the video where the specific sounds are generated according to the search request, and playbacks the videos one to five seconds longer than the ending time of the videos where the specific sound are ended.

7. The digital video recorder system according to claim 1, wherein the DVR device displays and stores the range information where the specific sounds are generated in the entire video recording file and reproduces the video range where the specific sounds are generated according to the search request.

8. The digital video recorder system according to claim 1, wherein the DVR device generates and stores, in a pair, one video file and at least one specific sound file for at least one specific sound generated in one video file.

9. The digital video recorder system according to claim 1, wherein the DVR device generates and stores, in a pair, the sound video information file having the range information where one video file and at least one specific sound are generated by the range information where at least one specific sound generated in one video file is generated.

10. The digital video recorder system according to claim 1, wherein the DVR device synchronizes and compresses and stores the sound and video input through the sound input unit and the video recorder unit and records the range information where the specific sounds are generated for each sound, and reproduces the video in the video range where the specific sounds are generated together with the sound according to the search request.

11. The digital video recorder system according to claim 1, wherein the DVR device generates and stores one sound file and one video file for the specific sound in a pair.

12. The digital video recorder system according to claim 1, wherein the DVR device includes:
a sound video input unit that receives the video and sound information on an analog signal from the camera and the microphone and converts it into a digital signal;
a sound recognizing unit that analyzes sound data transferred from the sound video recorder unit and classifies the sound type;
an video managing unit that manages the video in a range where general recording videos and the specific sounds are generated;
a sound video file storage unit that manages the video range where the sounds are generated in a file and stores it in a database and classifies the general recording videos and the videos for the specific sound and stores them as the video file;
a database that stores the general recording video file and the video file for each specific sound;
a sound video searching unit that searches the video file stored in the database through the sound video file storage unit according to the search request of the videos; and
a sound video display managing unit that is connected to a user interface to provide an video searching function and reproduces the video file searched through the sound video searching unit by an output device.

13. The digital video recorder system according to claim 12, wherein the sound recognizing unit classifies the sound type through the sound recognizing algorithm after detecting an endpoint for the sound data and when the sound type is as the specific sound, provides the sound type and the starting time and ending time information on the sound to the video managing unit and the sound video file storage unit.

14. The digital video recorder system according to claim 12, wherein the sound recognizing unit determines whether the input sound data are similar to the sound data stored in the database by the pattern classifying algorithm to determine the sound type.

15. The digital video recorder system according to claim 12, wherein the sound recognizing unit detects the endpoint by using a zero crossing rate (ZCR) and energy for the input sound data and applies a linear predictive coding (LPC) and a mel frequency cepstral coefficients (MFCC) to extract features and determines the sound type by using the pattern classifying algorithm alone or in at least two thereof.

16. The digital video recorder system according to claim 12, wherein the video managing unit displays the sound type and the time range information transmitted from the sound recognizing unit on the DVR recording screen as a sound waveform and stores and manages the videos.

17. The digital video recorder system according to claim 12, wherein the sound video file storage unit includes the information on the sound type, the sound generating time, and the sound ending time and stores the range information between the sound generating time and the sound ending time based on the time or the number of frames in the millisecond unit.

18. The digital video recorder system according to claim 12, wherein the database is configured to include:
an video DB that stores the general video recording file;
a sound video DB that stores the video file in the time range where sounds are generated; and
a sound video information DB that stores the path information and the time range information on the video file for each sound type.

19. The digital video recorder system according to claim 12, wherein the sound video searching unit provides the keyword search, the search for each sound type, and the tag search and brings the video range information where the sounds are generated on the video DB by using the video file path information and the time range information stored in the sound video information DB or brings the path information on the video file where the sounds stored in the sound video DB are generated.

20. The digital video recorder system according to claim 12, wherein the sound video display managing unit provides functions of the time search, the sound type search, the keyword search, the range search, the section search, the tag search, and the channel search for the sound video file.

21. The digital video recorder system according to claim 12, wherein the sound video display managing unit outputs only the videos in a range where the specific sounds are generated or simultaneously outputs the videos and the sounds.

22. The digital video recorder system according to claim 19, wherein the tag search represents time, minute, and second where the specific sounds are generated on a graph representing time, minute, and second corresponding to specific year, month, and day in a scale form and represents a sound type on a lower end of the scale in a text.

23. A digital video recorder system, comprising:
a camera that input videos;
a microphone that inputs sounds;
a sound video recorder unit that converts videos and sounds input from a camera and a microphone into digital signals;
a sound recognizing unit that analyzes the sounds converted into the digital signals and classifies a sound type;
an video managing unit that manages the videos recorded in a range where general recording videos and specific sounds are generated;
a sound video file storage unit that stores in the database the range information concerning the videos where the general videos and the specific sounds are generated and range information where the specific sounds are generated;
an video DB that stores a general video recording file;
a sound video DB that stores an video file in a time range where the sounds are generated;
a sound video information DB that stores path information and time range information on the video files for each sound type;
a sound video searching unit that searches the video information stored in the video DB, the sound video DB, and the sound video information DB according to the search request of the video information where the specific sounds are generated; and
a sound video display managing unit that is connected to a user interface and provides the search function of the video information and reproduces the searched video information.

24. The digital video recorder system according to claim 23, wherein the sound recognizing unit classifies the sound type through the sound recognizing algorithm after detecting an endpoint for the sound data and when the sound type is as the specific sound, provides the sound type and the starting time and ending time information on the sound to the video managing unit and the sound video file storage unit.

25. The digital video recorder system according to claim 23, wherein the sound recognizing unit determines whether the input sound data are similar to the sound data stored in the database by the pattern classification algorithm to determine the sound type.

26. The digital video recorder system according to claim 23, wherein the sound video file storage unit includes the information on the sound type, the sound starting time, and the sound ending time and stores the range information between the sound starting time and the sound ending time based on the time or the number of frames in the millisecond unit.

27. The digital video recorder system according to claim 23, wherein the sound video file storage unit generates and stores only one sound video file for each specific sound.

28. The digital video recorder system according to claim 23, wherein the sound video file storage unit generates and stores range information where sounds are generated for each specific sound.

29. The digital video recorder system according to claim 23, wherein the sound video file storage unit displays, stores and playbacks only the video file of the section where specific sounds are generated, based on a search request.

30. The digital video recorder system according to claim 23, wherein the sound video file storage unit generates and stores, in a pair, one video file and at least one specific sound file for at least one specific sound generated in one video file.

31. The digital video recorder system according to claim 23, wherein the sound video file storage unit generates and stores, in a pair, the sound video information file having the range information where one video file and at least one specific sound are generated by the range information where at least one specific sound generated in one video file is generated.

32. The digital video recorder system according to claim 23, wherein the sound video file storage unit compresses and sores the synchronized video and sounds input through the camera and the microphone.

33. The digital video recorder system according to claim 23, wherein the sound video file storage unit generates and stores one sound file and one video file for the specific sounds in a pair.

34. A method for operating a digital video recorder system, comprising:
receiving videos and sound data;
recognizing specific sounds through the analysis of the sound data;
storing only video data in a database as an video file of the corresponding time period, including a sound type and information on generating time and ending time when the specific sounds are recognized; and
searching videos in a database according to requested conditions and reproducing them as the output of the sounds and the videos when the search of the stored video file is detected.

35. The method for operating a digital video recorder system according to claim 34, wherein the recognition of the specific sound extracts features by using linear predictive coding (LPC) and mel frequency cepstral coefficients (MFCC) and determines and recognizes the sound type by using one or at least two of pattern matching algorithms of dynamic time warping (DTW), hidden Marcov model (HMM), artificial neural network (ANN), support vector machine (SVM), and fuzzy.

36. The method for operating a digital video recorder system according to claim 34, wherein the recognition of the specific sound determines the sound type similarity between the sound data and the reference sound data stored in the database by using any one of the dynamic time warping (DTW), the hidden Marcov model (HMM), the artificial neural network (ANN), the support vector machine (SVM), and the fuzzy.

37. The method for operating a digital video recorder system according to claim 34, wherein when the generation of the specific sounds are recognized, the video recording of the range starts at a time point when the specific sounds are generated, and when the ending of the specific sound is detected, the recording of the range videos are ended, and the video file is generated based on the kinds of sounds, the sound generation time and the ending time, and the sections between the sound generation time and the ending time are classified by the time of milliseconds or the number of video frames.

38. The method for operating a digital video recorder system according to claim 34, wherein the video file stored in the database classifies and stores the information on the general video recording file, the video file where the sounds are generated, and the video file for each sound.

39. The method for operating a digital video recorder system according to claim 34, wherein the video file stored in the database provides the time search, the sound type search, the keyword search, the range search, the section search, the tag search, and the channel search on a screen connected to a user interface, and outputs only the videos in a range where the specific sounds are generated or simultaneously outputs the videos and the specific sounds according to the reproduction of the searched video file.

40. A method for operating a digital video recorder system, comprising:
receiving videos and sound data;
recognizing specific sounds through the analysis of the sound data;
synchronizing and compressing and storing videos and sound data;
storing an information on a sound type, generating time and ending time in a database when the specific sounds are recognized; and
searching an video file in the database according to requested conditions when the video search is requested for a range where the stored specific sounds are generated and reproducing the video range corresponding to the generating time and the ending time where the specific sound is recognized as the output of the sound and videos.

41. The method for operating a digital video recorder system according to claim 40, wherein when the video search is the time search, if year, month, and day are input and time is selected, the video list for each sound generated at the corresponding time is read and displayed in the database and if the corresponding video is selected, the video and the sound are output.

42. The method for operating a digital video recorder system according to claim 40, wherein when the video search is the search of the sound type, if the sound type is selected or the sound type is input by keywords, the video list corresponding to the sound type is read and displayed in the database and if year, month, day, and time information are further input, the video list generated at the corresponding time is displayed and if the specific video is selected, the corresponding video and sound are output.

43. The method for operating a digital video recorder system according to claim 40, wherein when the video search is the tag search, if year, month, and day are selected, the video information generated at the corresponding day are read in the database and is represented by the scale of time unit, minute unit, and second unit and the sound type is represented at the upper end of the scale of the second unit in a text form and when the text (tag) is selected or any location on the range of the scale of the second unit is selected, the corresponding video is output together with sound.
